(19) United States
(12) Patent Application Publication
(10) Pub. No.: US 2026/0281905 A1
(43) Pub. Date: Sep. 17, 2026

(54) SYSTEMS AND METHODS FOR PREDICTIVE SLEEP SCHEDULING FOR BATTERY-POWERED DEVICES

(71) Applicant: ProdataKey, Inc., Draper, UT (US)

(72) Inventors: Evan Orme, Lindon, UT (US); Michael Scott Redd, Draper, UT (US)

(21) Appl. No.: 19/427,544

(22) Filed: Dec. 19, 2025

Related U.S. Application Data
(60) Provisional application No. 63/746,582, filed on Jan. 17, 2025.

(51) Int. Cl. H04W 52/02; H02J 7/45; H04W 52/26; H02J 107/20

(52) U.S. Cl. CPC H04W 52/0258; H02J 7/45; H04W 52/0248; H04W 52/265; H02J 2107/20

(57) ABSTRACT

A system and method for implementing a system and method for optimizing energy efficiency in networked endpoints and other battery-powered networked endpoints through predictive scheduling of sleep cycles and wake cycles, and by leveraging historical activity data, contextual cues such as calendar events and geolocation, and user interaction patterns, a dynamic forecasting model predicts periods of inactivity and schedules power-saving modes without compromising user experience, and wherein the system may use machine learning to refine wake and sleep predictive timetables based on real-time feedback, ensuring adaptability and accuracy and thereby extend battery life, reduce maintenance costs, and enhance the operational efficiency of wireless access control systems.

### BACKGROUND

### Field of the Invention

This invention relates generally to battery-powered wireless devices, and specifically networked endpoints. The disclosure relates to power-management and connectivity-management in battery-powered and networked wireless devices (e.g., wireless locks, sensors, panels, etc.). In particular, it concerns predictive wake and sleep scheduling that leverages diverse data sources to conserve battery energy while maintaining acceptable responsiveness.

### Description of Related Art

Access control systems that utilize wireless locks use batteries to provide power to the wireless locks. Minimizing power consumption by any battery-operated network device is therefore of critical importance. Furthermore, wireless locks are becoming a standard in access control systems due to their ease of use and wireless capabilities. However, one of their major drawbacks is the recurring expense of battery replacements. These costs are not limited to the batteries themselves but also include labor costs associated with servicing and replacement. In environments with multiple wireless locks, such as commercial buildings, hotels, or residential complexes, the accumulated costs can be substantial, making battery optimization a pressing need.

The energy consumption of wireless locks stems from various components that draw power, such as RF devices, lights, screens, and communication modules. These components often remain active even when the wireless lock is not in use, consuming power unnecessarily. This inefficiency directly reduces battery life, leading to more frequent replacements, which increase operational costs and decrease sustainability.

Conventional power-saving methods in wireless locks rely on static wake and sleep schedules or basic heuristics to manage energy consumption. Static or heuristic wake and sleep schedules often mismatch real usage, wasting energy during inactivity or causing inconvenient latency when users attempt access during a sleep window. These approaches rarely consider context (calendar/holiday effects, business type, headcount, cohort behavior across sites) or network cues and seldom include a continuous feedback loop to correct poor predictions. Similarly, the activity of related devices, like a tenant entering a parking garage, could provide valuable cues to predict subsequent wireless lock usage but is rarely utilized.

Many devices also operate offline for long periods, complicating centralized update strategies. While these approaches offer some reduction in power usage, they fail to adapt to dynamic access patterns or unique user behaviors. As a result, wireless locks may remain active during periods of inactivity or, conversely, go into low-power mode when access is expected, either wasting energy or causing usability issues. There is a need for systems that (i) predict device inactivity with higher confidence from richer information, (ii) schedule sleep without unacceptable responsiveness penalties, and (iii) operate at scale across heterogeneous sites and device classes.

Current heuristic models require significant historical data to make accurate predictions about usage patterns. In new installations or locations with irregular access schedules, these models lack the necessary information to function effectively. This results in a period of inefficiency where the system cannot optimize power consumption, undermining the goal of extending battery life.

Wireless locks often operate as standalone devices without leveraging supplementary data from user activity, such as geolocation information or interactions with mobile apps. These data points could offer critical insights into user behavior, enabling better predictions of wireless lock activity. The lack of integration with these data sources represents a missed opportunity for energy optimization.

Static or even semi-static power-saving schedules fail to adjust in real-time to changing usage patterns. For example, unexpected activity or changes in access schedules (such as overtime workdays or special events) may not be accounted for, causing the wireless lock to either waste energy or fail to respond promptly. This inflexibility limits the effectiveness of existing solutions.

When a wireless lock enters a low-power state at an inopportune time, it can cause significant delays in responding to access attempts. These delays, although often brief, can lead to frustration among users, especially in environments where quick and seamless access is critical. This trade-off between power efficiency and responsiveness highlights a significant flaw in current systems.

Many systems lack a feedback loop to refine their predictive models based on real-world performance. Without this feedback, the accuracy of predictions remains static, and the system cannot learn from its mistakes. For example, if a model consistently misjudges active periods, it should adjust its parameters dynamically to improve future forecasts. This absence of adaptability restricts long-term efficiency gains.

A significant proportion of wireless locks operate offline, meaning they lack a constant connection to a central system or network. This makes it challenging to implement advanced power-saving features, as predictions cannot be distributed or updated in real-time. This limitation highlights the need for innovations that can work with both online and offline wireless lock systems.

In facilities with a high number of wireless locks, the inefficiencies of current power management systems are magnified. The cumulative energy waste across hundreds or thousands of devices represents a significant operational challenge. A scalable solution that can optimize battery usage across multiple devices is essential to address the needs of large-scale deployments effectively.

It would be an advantage over the prior art to create a system and method for addressing these interconnected issues by introducing a predictive, AI-driven power management system that integrates diverse data sources, learns from feedback, and dynamically adapts to usage patterns, significantly improving battery efficiency while maintaining user experience.

### BRIEF SUMMARY

The present invention is a system and method for optimizing energy efficiency in wireless locks and other battery-powered networked devices through predictive scheduling of sleep intervals, and by leveraging historical activity data, contextual cues such as calendar events and geolocation, and user interaction patterns, a dynamic forecasting model predicts periods of inactivity and schedules power-saving modes without compromising user experience, and wherein the system may use machine learning and/or AI resources to refine predictions based on real-time feedback, ensuring adaptability and accuracy and thereby extending battery life, reduce maintenance costs, and enhance the operational efficiency of wireless access control systems.

### BRIEF DESCRIPTION OF THE SEVERAL VIEWS OF THE DRAWINGS

FIG. 1 is a block diagram of a first embodiment of a system for reducing energy consumption of a battery-powered wireless networked endpoint.

FIG. 2 is a block diagram of a second embodiment of a system for reducing energy consumption of a battery-powered wireless networked endpoint.

FIG. 3 is a block diagram of a third embodiment of a system for reducing energy consumption of a battery-powered wireless networked endpoint.

FIG. 4 is a flowchart showing the steps in a method of the invention.

### DETAILED DESCRIPTION

Reference will now be made to the embodiments of the invention in which the embodiments will be discussed so as to enable one skilled in the art to make and use the embodiments of the disclosure. It is to be understood that the following description illustrates embodiments of the present disclosure and should not be viewed as narrowing the claims which follow.

The following definitions may be useful to understand the description of the embodiments. Sleep may be a state in which the device suspends most radios/processes to minimize current draw and wake sources may remain active.

A Local Credential may be a device-proximate authentication signal (phone/fob/NFC/BLE) detected by the endpoint.

A Cloud-Initiated Command may be an action invoked from an interface that traverses site coordinator-hub-networked device, subject to the networked endpoint’s listen interval.

Cohort features may be statistics/features derived from similar devices/sites (e.g., hotel vs. office) used to improve forecasting in the absence of rich local history.

Interaction class means a category of device interactions that share similar latency requirements, including at least a local-credential interaction class and a remote command interaction class; additional classes (e.g., status query, configuration update, diagnostics) may be used. For each interaction class, latency service-level objectives (SLOs) may be defined with percentile targets and measurement windows.

Thresholding means comparing a computed value (e.g., a predicted probability of interaction, a score, a cost, an energy–latency objective, or any monotone transform thereof) to one or more decision thresholds to select among alternatives.

The first embodiment of the invention may operate as a predictive energy optimization system for networked endpoints such as wireless locks, utilizing historical data, contextual cues, and AI-driven algorithms to schedule wake and sleep intervals. The system focuses on maximizing battery life while ensuring user convenience and responsiveness.

The device that may control the operation of the networked endpoints can be implemented as any system at a particular site that is associated with the networked endpoints.

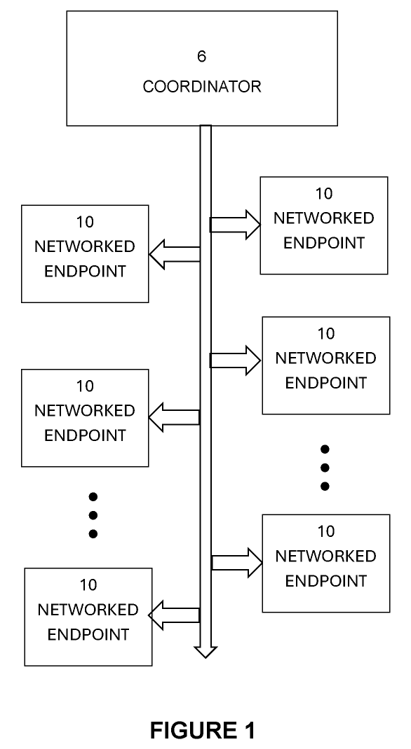

FIG. 1 is a block diagram illustrating the first embodiment of the invention. In this first and most basic embodiment, a coordinator 6 communicates directly to or through intermediate devices to a plurality of networked endpoints. The coordinator 8 may be a device dedicated to controlling the networked devices 10, or it may have other functions as well. The networked endpoints 10 may be any networked device that is battery operated and may benefit from a power-saving control system that tells the networked endpoint 10 when it should be in a listen cadence or wake cycle that is ready to receive input, and when it should be a sleep cycle that can still receive input, but will operate with an inherent latency because it is not in the wake cycle where it is optimized (ready) to receive input.

It should be understood that the networked endpoints 10 may have more than one level of sleep or wake cycle.

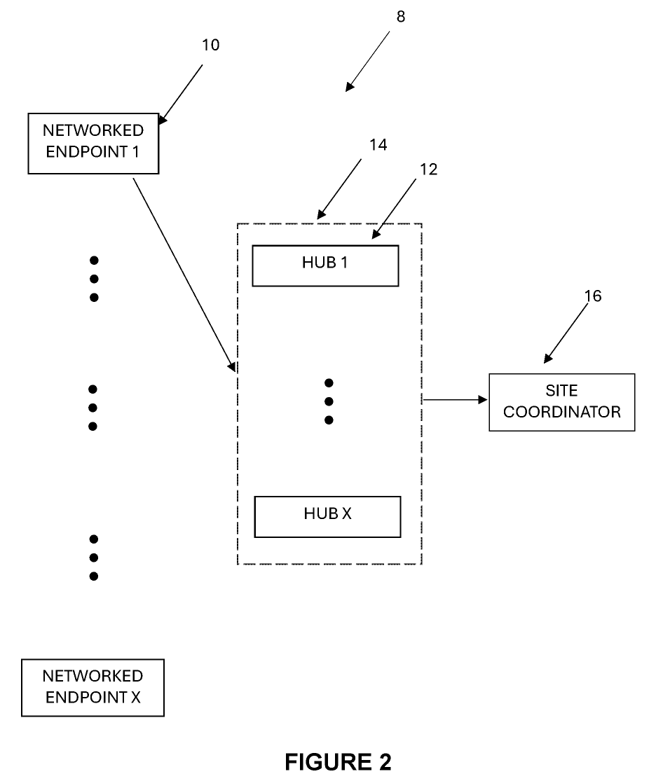

FIG. 2 shows a second embodiment of an implementation of a door access system 8. The exact implementation may vary, but a typical system may include a site coordinator 16, a plurality of hubs 12, and a plurality of networked endpoints 10. As an illustrative example, the networked endpoints 10 are going to be illustrated in the first embodiment as wireless locks 10, with each of the wireless locks being connected to the site coordinator 16 through one of the plurality of hubs 12.

It should be understood that use of the wireless locks 10 should not be considered as limiting the type of networked endpoints that may be used in the first embodiment but serve only as an example. In the first embodiment, the hubs 12 may be grouped together in a hubnet 14. No specific hub is assigned to each of the plurality of locks 10. Instead, the site coordinator 16 is used to control which of the hubs 12 is used with each of the plurality of wireless locks 10. The hubs 12 are only acting as pass-through devices.

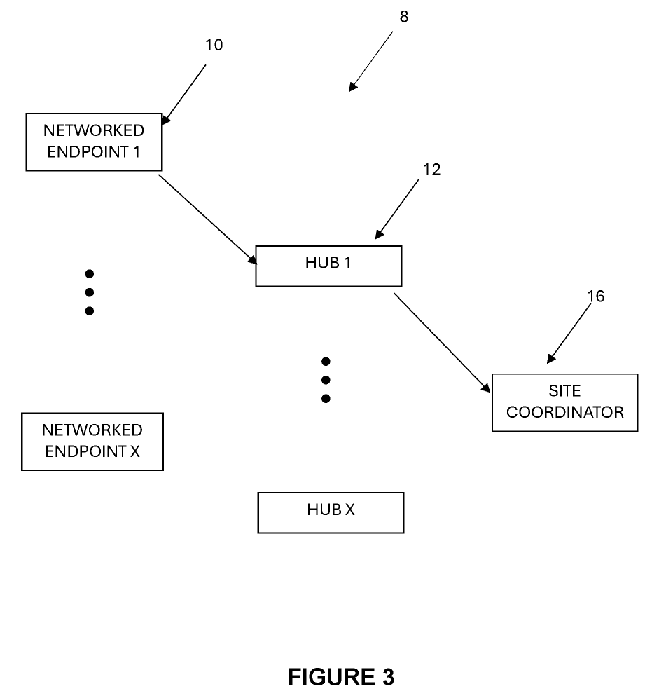

Alternatively, FIG. 3 is a third embodiment that is a modification of FIG. 2 in that the site coordinator 16 is not controlling which hub 12 is assigned to each of the wireless locks 10. What is important is that the site coordinator is operating as a director controlling wake and sleep cycles for each of the wireless locks 10.

FIGS. 2 and 3 provide possible hardware systems that may implement the invention. Turning to a first embodiment of the method for generating a predictive timetable begins with determining per-device sleep cycle timetables (e.g., a rolling weekly plan, or a rolling daily plan) and enforces data privacy/segmentation across customers and sites. Networked endpoints (e.g., wireless locks) run low-power firmware with states such as active, listen/poll, and sleep, with hardware wake cycle sources including but not limited to timers, interrupts, credential readers, motion, and proximity triggers.

Data sources for generating the predictive timetable go beyond current state of the art sources and include but should not be considered as limited to the following: local history, where device event logs (successful/failed access attempts, time-of-day/week patterns) are recorded; cohort history, where events from similar devices and similar sites (e.g., hospitality vs. office), are weighted by declared installation type and population size (e.g., 3 users vs. 500 users); calendar context, using workdays, weekends, holidays, and special schedules (including leap-year timing where relevant); configuration, that considers customer/site metadata (business type, headcount), installer inputs, and policy constraints (e.g., maximum permitted latency); anomaly logs, where mispredictions are captured as negative examples, so the model learns to avoid conditions that produced poor experiences; and geospatial/proximity cues (optional), using device pre-wake when an authorized user approaches (geofence, garage/outer-gate access preceding a door event). The embodiments may use any information that can legally and ethically be used to improve forecasting, while keeping identity/tenant boundaries intact.

When generating the predictive timetable of wake cycles and sleep cycles for each networked endpoint 10, a forecasting model (rules, statistical methods, and/or machine learning) may produce a sequence of time windows with target wake cycles (or listen intervals) and sleep cycles. The predictive timetable seeks to minimize expected energy use subject to latency Service Level Objectives (SLOs) for (i) local credential interactions (phone/fob/NFC/BLE) and (ii) cloud-initiated commands that traverse the coordinator to hub to networked endpoint path. The model therefore continuously adapts using observed performance and anomaly feedback to reduce future sleep/wake cycle errors.

More or longer sleep cycles of the networked endpoints 10 may yield greater energy savings but also increases wake-to-ready time for both local and cloud-command paths. The system may expose percentile bands (e.g., P50/P95) and admit scheduled pre-wake near predicted activity peaks to restore responsiveness.

The predictive timetable is distributed securely to each of the networked endpoints 10. Online networked endpoints 10 may receive rolling updates, while offline networked endpoints may operate from pre-calculated timetables until they reconnect.

The door access system 8 in the embodiments balances battery conservation against latency for: (a) local credential interactions (e.g., phone/fob/card at a lock), and (b) cloud-initiated commands (e.g., UI unlock over backhaul), explicitly acknowledging that deeper sleep cycles improve energy savings but can increase response time.

Upon installation, a networked endpoint connects to a centralized system or cloud service, which serves as the center for data collection and processing. The system may begin collecting baseline usage data, including user interactions and access patterns.

The networked endpoint 10 may record activity data, such as access attempts, frequency of use, and times of activity. This data is aggregated with information from other networked endpoints 10 or devices on the same network, creating a comprehensive dataset for predictive analysis.

The system may also integrate contextual information, such as calendar-based schedules (e.g., business hours, holidays, weekends) and related device activity. For example, if a tenant scans into a parking garage, the system predicts subsequent access to their residence and prepares the networked endpoint 10 accordingly.

User interactions with mobile apps or other remote-control systems may also be tracked. This includes app activity, geolocation data, and manual overrides, which provide additional insights into user behavior.

One particularly unique aspect is using an AI model to process the collected data to identify patterns and predict periods of inactivity. Using machine learning, the model may dynamically adjust its predictions based on feedback from actual networked endpoint 10 usage.

Based on the AI's predictions, the system may generate a sleep predictive timetable for the networked endpoints 10. This predictive timetable prescribes specific intervals for the networked endpoints 10 to enter a low-power state while ensuring they remain active during predicted access times.

The wake and sleep predictive timetable may be distributed to the networked endpoints 10 via a secure communication channel. For online networked endpoints, this occurs in real-time, while offline networked endpoints 10 may receive updates during periodic connections.

The networked endpoint 10 may execute the prescribed wake and sleep timetable locally, entering sleep during predicted inactivity, polling/listening more frequently near predicted peaks, and honoring override triggers such as a local credential approach, motion detection, or user-initiated remote wake. Unexpected activity may prompt temporary escalation of listen frequency and is sent upstream as an anomaly for model learning.

The site coordinator 16 maintains journals per device: predicted vs. actual events, sleep depth in effect, latency experienced, and any anomaly tags. Operators can view why-moved/why-slept timelines and adjust high-level policy (e.g., cap on permitted command latency). The model uses these journals to tune features and reweight data sources (e.g., increasing the importance of calendar or cohort features that have been predictive for a given site type).

The networked endpoint 10 may override its wake and sleep predictive timetable if it detects unexpected activity, such as a user approaching with a proximity credential (e.g., NFC or BLE). This ensures responsiveness even during sleep cycles.

Additional sensors, such as temperature or motion sensors, provide real-time data to refine behavior of the networked endpoints 10. For instance, extreme temperature changes might prompt the networked endpoint 10 to adjust its polling frequency to preserve functionality.

The networked endpoint 10 may continuously monitor its performance and report anomalies, such as failed predictions or unexpected access attempts, back to the site coordinator 16. This feedback may be used by the site coordinator 16 to improve future forecasts by adjusting the AI model.

Users may manually wake the networked endpoint 10 via a remote app or physical interaction. These overrides are logged and incorporated into the prediction model to refine future wake and sleep predictive timetables.

If the wake and sleep predictive timetable fails to align with actual usage patterns of a network endpoint 10, the site coordinator 16 may trigger an immediate update to the AI model. This minimizes disruption and ensures future wake and sleep predictive timetables are more accurate.

For users with mobile apps, geolocation data predicts proximity to the networked endpoint 10. For example, when a user approaches the building, the system 8 wakes the networked endpoint 10 to prepare for access.

In installations with multiple networked endpoints 10, the site coordinator 16 creates wake and sleep predictive timetable for each individual networked endpoint 10. For instance, if a user accesses one networked endpoint 10, nearby networked endpoints might remain active briefly, anticipating subsequent usage.

The networked endpoint 10 may also dynamically transition between power cycles (e.g., active, standby, sleep) based on the prescribed predictive timetable and real-time events. These transitions are smooth to prevent noticeable delays.

Unexpected events, such as unplanned access during holidays, are detected through real-time monitoring. The site coordinator 16 may adapt by waking the networked endpoint 10 or recalculating wake and sleep predictive timetables as needed.

For offline networked endpoints 10, pre-calculated schedules may be stored locally. During periods of disconnection, the networked endpoints 10 may operate independently, executing its prescribed wake and sleep predictive timetable without external input.

All communication between the networked endpoint 10 and a central system such as the site coordinator 16 may be encrypted to prevent unauthorized access. The networked endpoint's 10 firmware may be designed to prevent tampering with wake and sleep predictive timetables.

Application payloads may be end-to-end encrypted between networked devices 10 and the site coordinator 16; hubs 12, when present, relay ciphertext and need not retain long-term keys. Data used for modeling can be de-identified and partitioned per customer/tenant; cohort features are derived in a manner consistent with privacy policy. Firmware protects wake and sleep predictive timetable integrity and securely updates them.

Advantageously, the system 8 may be designed to scale across large installations, managing wake and sleep predictive timetables for thousands of networked endpoints 10 simultaneously. Each networked endpoint 10 may operate independently but benefits from shared data and centralized coordination. The site coordinator 16 may service thousands of networked devices 10, generating wake and sleep predictive timetables with site-class and occupancy awareness (e.g., a hotel vs. an office). Cohort learning allows cold-start performance in new installations that lack long local history. The approach generalizes other battery-powered IoT devices that benefit from context-aware sleep.

In deployments employing hubs 12, networked endpoints 10 bind to the site coordinator 16 and communicate through any of several hubs. Hubs 12 may report visibility and health; the system chooses serving paths based on quality and capacity while networked devices 10 follow their wake and sleep predictive timetables. Hub 12 failures trigger seamless failover without re-pairing, because application keys terminate at the site coordinator 16. This connectivity layer scales to large sites and can coexist with wake and sleep predictive timetables.

In the embodiments, the site coordinator 8, 16 may monitor battery health of each networked endpoint 10 and alert users when replacements are needed. This proactive approach ensures uninterrupted operation while avoiding unnecessary replacements.

The site coordinator 8, 16 may be extended to other battery-powered IoT devices, applying the same predictive power management principles to optimize energy usage of networked endpoints 10.

Over time, the AI model may become more accurate, incorporating new data and adapting to changing user behaviors. This continuous improvement ensures the system 8 remains effective in conserving energy and enhancing user experience.

The embodiments may operate as a dynamic, intelligent system that balances energy conservation with seamless functionality, transforming how networked endpoints 10 and other battery-powered devices manage power. The embodiments extend battery life while preserving user experience; reduce truck rolls and battery waste; provide cold-start behavior via cohort learning; adapt quickly via anomaly-driven feedback; and optionally leverage multi-hub connectivity for resilience without complicating device pairing.

Additional aspects of the embodiments include the site coordinator 8, 16 derives cohort features from a population of networked endpoints 10 sharing a device class or site type and reduces a weight of the cohort features relative to local device history as the local device history accumulates. The site coordinator 8, 16 is also configured to schedule pre-wake intervals proximate to predicted activity peaks and to expose target percentile latency bands for local-credential interactions and remote commands.

Firmware of the networked endpoint 10 may be configured to apply a grace interval of elevated listening following a detected local interaction and to revert to the wake and sleep predictive timetable upon expiration of the grace interval. The firmware may also maintain a multi-day cache of the wake and sleep predictive timetable for offline execution and to verify integrity and freshness of an updated timetable prior to adoption. The firmware may also escalate from a planned sleep state to a conservative listen mode when the site coordinator 6, 16 determines that a threshold number of scheduled wake events were missed.

The site coordinator 6, 16 may compute per-window energy estimates for at least a wireless communication subsystem and a computation subsystem and selects the wake and sleep predictive timetable by optimizing battery savings subject to a continuity constraint that limits rapid alternation of sleep depths across adjacent time windows. The site coordinator may also calibrate predicted probabilities of interaction such that thresholding corresponds to a target percentile latency for a defined interaction class.

A credential interface of the networked endpoint 10 comprises at least one of a radio-frequency identifier reader, a Bluetooth® interface, a keypad, or a proximity sensor and is treated as a local trigger by the firmware.

In summary, the first embodiment is a system for conserving energy in a battery-powered wireless device, comprising a site coordinator implemented by one or more processors and memory configured to generate, for a networked endpoint, a device-specific timetable that specifies, for plural future time windows, a sleep cycle and a wake cycle, firmware on the networked endpoint configured to execute the timetable by (i) entering a sleep cycle during at least one of the plural future time windows, (ii) adopting the wake cycle during at least another of the plural future time windows, and (iii) honoring local overrides that temporarily elevate listening in response to detected local activity, and wherein the site coordinator selects the sleep cycle and the wake cycle responsive to features derived from at least device history, calendar context, installer configuration, and anomaly feedback, and wherein the timetable is selected to satisfy a latency service-level objective (SLO) for at least one interaction class while reducing expected battery consumption.

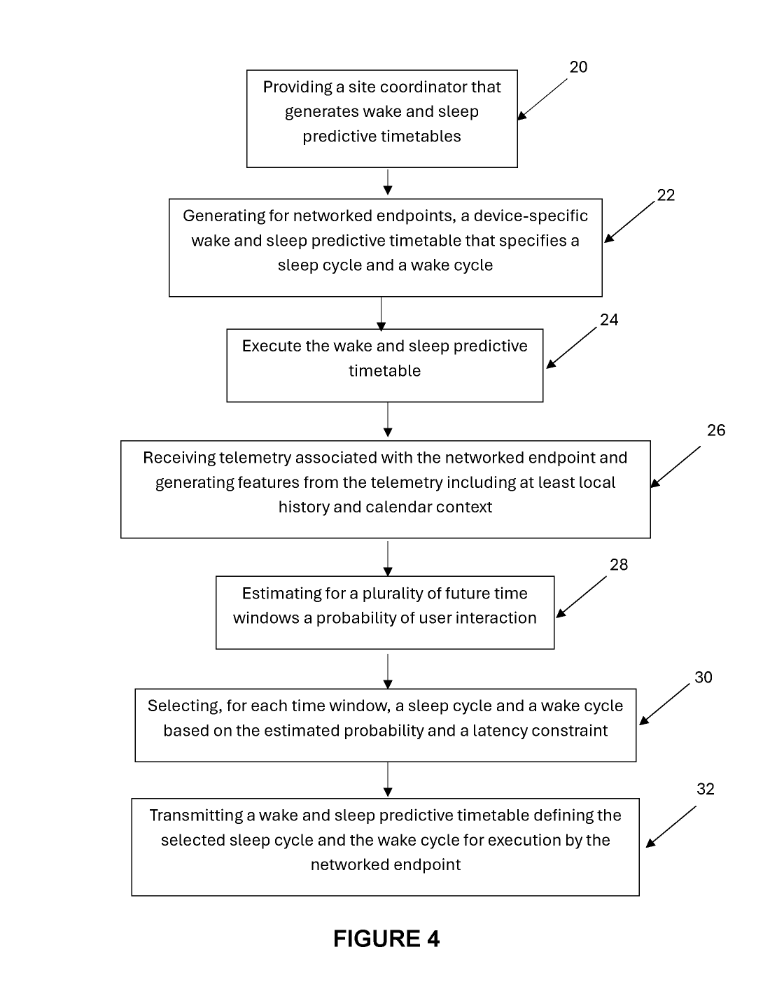

FIG. 4 provides a flowchart outlining the method for reducing energy consumption of a battery‑powered wireless networked endpoint comprises providing a site coordinator to generate, for a networked endpoint, a device-specific wake and sleep predictive timetable 20 that specifies, for plural future time windows, a sleep cycle and a wake cycle 22, and firmware on the networked endpoint configured to execute the wake and sleep predictive timetable 24, receiving telemetry associated with the networked endpoint, generating features from the telemetry including at least local history and calendar context 26, estimating for a plurality of future time windows a probability of user interaction 28, selecting, for each time window, a sleep cycle and a wake cycle based on the estimated probability and a latency constraint 30, and transmitting a wake and sleep predictive timetable defining the selected sleep cycle and the wake cycle for execution by the networked endpoint 32.

Although the preceding description has been described herein with reference to particular means, materials, and embodiments, it is not intended to be limited to the particulars disclosed herein; rather, it extends to all functionally equivalent structures, methods, and uses, such as are within the scope of the disclosure. Accordingly, all such modifications are intended to be included within the scope of this disclosure. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A system for conserving energy in a battery-powered wireless networked endpoint, comprising:
a site coordinator implemented by one or more processors and memory configured to generate, for a networked endpoint, a device-specific wake and sleep predictive timetable that specifies, for plural future time windows, a sleep cycle and a wake cycle;
firmware on the networked endpoint configured to execute the wake and sleep predictive timetable by (i) entering a sleep cycle during at least one of the plural future time windows, (ii) adopting the wake cycle during at least another of the plural future time windows, and (iii) honoring local overrides that temporarily elevate listening in response to detected local activity; and
wherein the site coordinator selects the sleep cycle and the wake cycle responsive to features derived from at least device history, calendar context, installer configuration, and anomaly feedback, and wherein the timetable is selected to satisfy a latency service-level objective (SLO) for at least one interaction class while reducing expected battery consumption.

2. The system of claim 1 wherein the site coordinator further derives cohort features from a population of networked endpoints sharing a device class or site type and reduces a weight of the cohort features relative to local networked endpoint history as the local networked endpoint history accumulates.

3. The system of claim 1 wherein the site coordinator is further configured to schedule pre-wake intervals proximate to predicted activity peaks and to expose target percentile latency bands for local-credential interactions and remote commands.

4. The system of claim 1 wherein the firmware is further configured to apply a grace interval of elevated listening following a detected local interaction and to revert to the wake and sleep predictive timetable upon expiration of the grace interval.

5. The system of claim 1 wherein the firmware is further configured to maintain a multi-day cache of the wake and sleep predictive timetable for offline execution and to verify integrity and freshness of an updated wake and sleep predictive timetable prior to adoption.

6. The system of claim 1 wherein the site coordinator computes per-window energy estimates for at least a wireless communication subsystem and a computation subsystem and selects the wake and sleep predictive timetable by optimizing battery savings subject to a continuity constraint that limits rapid alternation of sleep cycles and wake cycles across adjacent time windows.

7. The system of claim 1 wherein a credential interface of the networked endpoint comprises at least one of a radio-frequency identifier reader, a Bluetooth® interface, a keypad, or a proximity sensor and is treated as a local trigger by the firmware.

8. The system of claim 1 wherein the site coordinator calibrates predicted probabilities of interaction such that thresholding corresponds to a target percentile latency for a defined interaction class.

9. The system of claim 1 wherein the firmware escalates from a planned sleep cycle to a conservative wake cycle when the site coordinator determines that a threshold number of scheduled wake events were missed.

10. The system of claim 1 wherein the site coordinator produces the wake and sleep predictive timetable as a rolling horizon with incremental updates, and the firmware adopts the incremental updates upon successful verification.

11. A computer‑implemented method for reducing energy consumption of a battery‑powered wireless networked endpoint, comprising:
providing a site coordinator to generate, for a networked endpoint, a device-specific wake and sleep predictive timetable that specifies, for plural future time windows, a sleep cycle and a wake cycle, and firmware on the networked endpoint configured to execute the wake and sleep predictive timetable;
receiving telemetry associated with the networked endpoint;
generating features from the telemetry including at least local history and calendar context;
estimating for a plurality of future time windows a probability of user interaction;
selecting, for each time window, a sleep cycle and a wake cycle based on the estimated probability and a latency constraint; and
transmitting a wake and sleep predictive timetable defining the selected sleep depths and the listen cadences for execution by the networked endpoint.

12. The method of claim 11 further comprises calibrating the estimated probabilities such that thresholding corresponds to a target percentile latency for a remote command class.

13. The method of claim 11 further comprising incorporating anomaly feedback identifying unexpected interactions and increasing a wake cycle in time windows similar to those associated with the anomalies.

14. The method of claim 11 wherein selecting the sleep cycle and the wake cycle further includes solving an optimization that maximizes expected battery savings subject to at least one continuity constraint that limits schedule chattering across adjacent time windows.

15. The method of claim 11 further comprising generating cohort features from networked endpoints deployed at sites with a common device class or business type and weighting the cohort features less as local history accumulates.

16. The method of claim 11 further comprising generating a grace interval of elevated wake cycle following detection of a local interaction at the networked endpoint.

17. The method of claim 11 wherein transmitting the wake and sleep predictive timetable further includes providing a rolling horizon of wake and sleep predictive timetable data sufficient for autonomous execution during an offline interval at the networked endpoint.

18. The method of claim 11 further comprising computing per‑window energy estimates for at least a wireless communication subsystem and a computation subsystem and selecting the sleep cycle and wake cycle based on the energy estimates and the latency constraint.

19. The method of claim 11 further comprising producing attribution summaries identifying feature groups that most influenced selection of the sleep cycle for a given time window.

20. The method of claim 11 further comprising detecting, via the site coordinator, that a threshold number of scheduled wake events were missed and, responsive thereto, updating the wake and sleep predictive timetable to increase wake cycles until a subsequent wake and sleep predictive timetable is adopted.
